(19) United States
(12) Patent Application Publication
(10) Pub. No.: US 2026/0074577 A1
(43) Pub. Date: Mar. 12, 2026

(54) ROTOR CORE AND AN AXIAL FLUX MOTOR INCLUDING THE SAME

(71) Applicants: HYUNDAI MOTOR COMPANY, Seoul (KR); KIA CORPORATION, Seoul (KR); GACHON UNIVERSITY OF INDUSTRY-ACADEMIC COOPERATION FOUNDATION, Seongnam-si (KR)

(72) Inventors: Soo Yong Park, Hwaseong-si (KR); Yong Woong Cha, Hwaseong-si (KR); Jae-Eun Jeong, Hwaseong-si (KR); Seong-Bin Jeong, Hwaseong-si (KR); Won-Ho Kim, Hwaseong-si (KR); Min-Su Youn, Yongin-si (KR); Min-Ki Hong, Seoul (KR); Dong-Woo Nam, Anyang-si (KR); In-Jun Yang, Seongnam-si (KR)

(73) Assignees: HYUNDAI MOTOR COMPANY, Seoul (KR); KIA CORPORATION, Seoul (KR); GACHON UNIVERSITY OF INDUSTRY-ACADEMIC COOPERATION FOUNDATION, Seongnam-si (KR)

(21) Appl. No.: 18/962,800

(22) Filed: Nov. 27, 2024

(30) Foreign Application Priority Data
Sep. 12, 2024 (KR) 10-2024-0125128

(51) Int. Cl. H02K 1/2796; H02K 1/16

(52) U.S. Cl. CPC H02K 1/2796; H02K 1/165

(57) ABSTRACT

Disclosed are a rotor core and an axial flux motor including the same. A rotor core according to an embodiment includes a plurality of block units formed in an arc shape, in which the plurality of block units are stacked in a radial direction, and the plurality of block units are coupled along a circumferential direction to form a ring shape.

### CROSS-REFERENCE TO RELATED APPLICATION

This application claims priority to and the benefit of Korean Patent Application No. 10-2024-0125128 filed in the Korean Intellectual Property Office on Sep. 12, 2024, the entire contents of which are incorporated herein by reference.

### BACKGROUND

### (a) Technical Field

The present disclosure relates to a rotor core and an axial flux motor including the same, and more particularly, to a rotor core that is easy to manufacture and has excellent performance in reducing iron loss due to eddy currents, and an axial flux motor including the same.

### (b) Description of the Related Art

An axial flux motor (AFM) is an electric motor in which a magnetic flux is directed axially and is known to have higher torque and efficiency compared to a radial flux motor (RFM) in which a magnetic flux is directed radially. The axial flux motor is easier to modularize and can reduce volume compared to the radial flux motor, making it useful in various fields.

In general, for a rotor of the axial flux motor, a soft magnetic composite (SMC) core is used; however, if the rotor is manufactured using the SMC core, there is no advantage in terms of reducing iron loss.

When manufacturing a rotor by applying electrical steel sheets with excellent characteristics for reducing iron loss, difficulties arise in rotor manufacture because each electrical steel sheet must be manufactured in a different size if stacked in a direction that reduces eddy currents.

The matters described in the background art section are prepared to enhance understanding of the background of the disclosure, and may include matters that have not been known to one having ordinary skill in the art to which the present technology belongs.

### SUMMARY

The present disclosure attempts to provide a rotor core that is easy to manufacture while reducing iron loss, an axial flux motor including the same, and an electric water pump including the axial flux motor.

A rotor core according to an embodiment includes a plurality of block units formed in an arc shape, in which the plurality of block units are stacked in a radial direction, and the plurality of block units are coupled along a circumferential direction to form a ring shape.

In some embodiments, the plurality of block units may have a diameter and a circumferential length, which increase from a radially inner side toward a radially outer side.

An axial flux motor according to an embodiment includes a stator assembly including a stator core and a coil wound around the stator core. The axial flux motor also includes a rotor assembly configured to rotate by an electromagnetic action with the stator assembly. The rotor assembly includes permanent magnets provided on both axial sides of the stator assembly, and rotor cores each provided on an outer axial side of the permanent magnets, the rotor cores including block segments in which a plurality of block units formed in an arc shape are stacked in a radial direction, and formed in a ring shape by the block segments being coupled in a circumferential direction.

In some embodiments, the plurality of block units of the rotor core may have a diameter and a circumferential length, which increase from a radially inner side toward a radially outer side.

In some embodiments, air gaps formed between the block segments may be filled with a glass fiber reinforcement polymer material.

In some embodiments, the permanent magnets may include first pole magnets and second pole magnets having a different polarity from the first pole magnets. The first pole magnets and the second pole magnets may be arranged at equal intervals along the circumferential direction.

In some embodiments, the first pole magnets may be arranged between the block segments and the stator core, and the second pole magnets may be arranged between boundaries of the block segments and the stator core.

In some embodiments, saturation of a back yoke may be minimized at the boundaries of the block segments.

In some embodiments, the stator core may include stator teeth arranged or spaced apart at set intervals along the circumferential direction. The stator core may also include stator slots each formed between the stator teeth, the coil being wound in the stator slots. The stator core may also include stator shoes extending from radially inner sides of the stator teeth toward the stator slots.

In some embodiments, the stator assembly may include a stator body, an upper stator coil wound on an upper surface of the stator body, and a lower stator coil wound on a lower surface of the stator body.

In some embodiments, the axial flux motor may further include block support members formed at lower portions of the block segments of the rotor core.

In some embodiments, the permanent magnets may be arranged between the block support members.

According to the disclosed embodiments, the rotor core can be easily manufactured from electrical steel sheets by manufacturing the rotor core from the block segments of the plurality of block units stacked in the radial direction.

Further, since the boundaries between the block segments used for the rotor back yoke are not located in the path of the magnetic flux, the effect on the motor performance can be minimized while allowing the manufacturing process to be carried out easily.

In addition, the effects that can be obtained or expected by the embodiments of the present disclosure are directly or implicitly disclosed in the detailed description of the embodiments of the present disclosure. In other words, various effects that may be expected by the embodiments of the present disclosure are disclosed in the detailed description described below.

### BRIEF DESCRIPTION OF THE DRAWINGS

Since the accompanying drawings are for reference in describing embodiments of the present disclosure, the technical spirit of the present disclosure should not be construed as being limited to the accompanying drawings.

FIG. 1 is a perspective view illustrating a configuration of an axial flux motor according to an embodiment of the present disclosure.

FIG. 2 is an exploded perspective view illustrating the configuration of the axial flux motor according to an embodiment of the present disclosure.

FIG. 3 is a perspective view illustrating a configuration of a rotor core of the axial flux motor according to an embodiment of the present disclosure.

FIG. 4 is a view for illustrating a magnetic flux path of the axial flux motor according to an embodiment of the present disclosure.

FIG. 5 is a view illustrating an analysis result for a magnetic flux saturation of the axial flux motor according to an embodiment of the present disclosure.

FIG. 6 is a perspective view illustrating a configuration of an axial flux motor according to another embodiment of the present disclosure.

FIGS. 7 and 8 are exploded perspective views illustrating the configuration of the axial flux motor according to an embodiment of the present disclosure.

FIG. 9 is a perspective view illustrating a configuration of an axial flux motor according to yet another embodiment of the present disclosure.

It should be understood that the above-referenced drawings are not necessarily drawn to scale, and present rather simplified representations of various features illustrating the basic principles of the present disclosure. The specific design features of the present disclosure, including, for example, specific dimensions, orientations, locations, and shapes, will be determined in part by the specific intended application and use environment.

### DETAILED DESCRIPTION

The terminology used herein is for the purpose of describing specific embodiments only and is not intended to limit the present disclosure. As used herein, the singular forms are intended to include the plural forms as well, unless the context clearly indicates otherwise. It is further understood that the terms “comprises” and/or “comprising”, when used in the present specification, specify the presence of stated features, integers, steps, operations, constitutional elements, and/or components, but do not preclude the presence or addition of one or more other features, integers, steps, operations, constitutional elements, components, and/or groups thereof. As used herein, the term “and/or” includes any one or all combinations of the associated listed items.

In the following detailed description, only certain embodiments of the present disclosure have been shown and described, simply by way of illustration. However, the present disclosure can be variously implemented and is not limited to the following embodiments.

The drawings and description are to be regarded as illustrative in nature and not restrictive. Like reference numerals designate like elements throughout the specification.

In addition, the size and thickness of each configuration shown in the drawings are arbitrarily shown for understanding and ease of description, but the present disclosure is not limited thereto. In the drawings, the thickness of portions, films, panels, regions, and the like, are exaggerated for clarity.

The suffixes “module” and/or “unit” or “part” for constitutional elements used in the following description are given or used interchangeably only for ease of writing the specification, and thus do not themselves have distinct meanings or roles.

In addition, in describing an embodiment disclosed, a detailed description of related known technologies has been omitted if it is determined that the detailed description makes the gist of the embodiment of the present specification unclear.

Further, the accompanying drawings are provided for helping to easily understand embodiments disclosed in the present specification, and the technical spirit disclosed in the present specification is not limited by the accompanying drawings, and it should be appreciated that the present disclosure includes all of the modifications, equivalent matters, and substitutes included in the spirit and the technical scope of the present disclosure.

Terms including an ordinary number, such as first and second, are used for describing various constituent elements, but the constituent elements are not limited by the terms.

In the following description, expressions described in singular can be interpreted as singular or plural unless explicit expressions such as “one” or “single”are used.

The terms are used only to discriminate one constituent element from another constituent element.

When a component, device, element, or the like of the present disclosure is described as having a purpose or performing an operation, function, or the like, the component, device, or element should be considered herein as being “configured to”meet that purpose or to perform that operation or function.

Hereinafter, an axial flux motor according to an embodiment is described in detail with reference to the accompanying drawings.

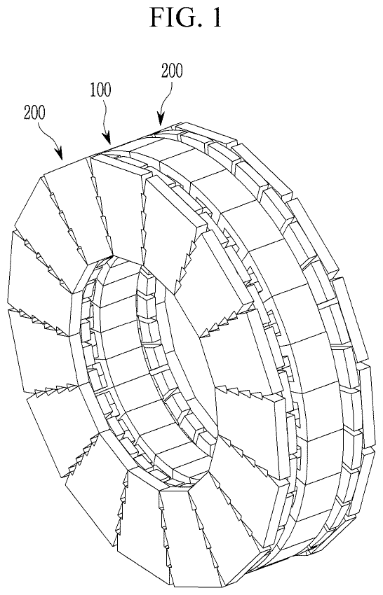

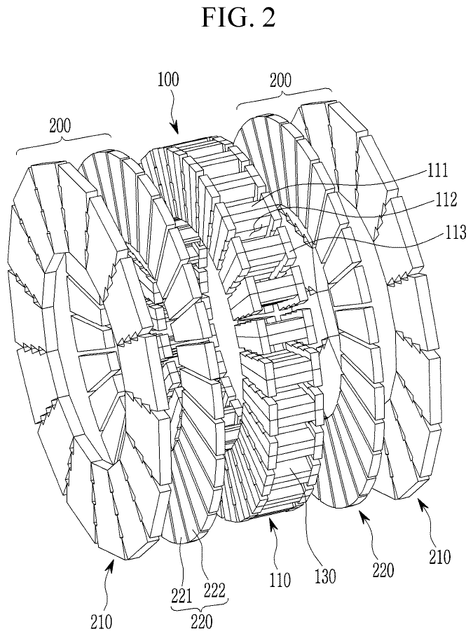

FIG. 1 is a perspective view illustrating a configuration of an axial flux motor according to an embodiment. FIG. 2 is an exploded perspective view illustrating the configuration of the axial flux motor according to the embodiment of FIG. 1.

As illustrated in FIGS. 1 and 2, an axial flux motor (AFM) according to an embodiment of the present disclosure is an electric motor in which a magnetic flux is directed axially and is known to have higher torque and efficiency compared to a radial flux motor (RFM) in which a magnetic flux is directed radially. In addition, the axial flux motor can achieve effects of easier modularization and reduced volume compared to the radial flux motor.

The axial flux motor according to an embodiment may include a stator assembly 100 and a rotor assembly 200.

The stator assembly 100 may include a stator core 110 and a coil 130 wound around the stator core 110.

The stator core 110 may include a plurality of stator teeth 111, stator slots 112 each formed between the stator teeth 111, and stator shoes 113 formed at both ends of the stator teeth 111.

The stator teeth 111 may be spaced apart at set intervals along a circumferential direction. The stator teeth 111 may be formed over a set distance in a radial direction. The stator teeth 111 may be a passage of magnetic flux.

The stator slots 112 may be each formed between the stator teeth 111, and the coil 130 may be wound therein.

The stator shoes 113 may extend from radially inner end portions of the stator teeth 111 toward the stator slots 112. The stator shoes 113 can reduce magnetic air gaps.

The rotor assembly 200 may include permanent magnets 220 and rotor cores 210.

The permanent magnets 220 may be provided on both axial sides of the stator assembly 100. The permanent magnets 220 may be arranged along the circumferential direction of the stator assembly 100. The permanent magnets 220 may include first pole magnets 221 and second pole magnets 222. The first pole magnets 221 (e.g., N pole) and the second pole magnets 222 (e.g., S pole) may have different polarities. The first pole magnets 221 and the second pole magnets 222 may be arranged alternately at set intervals along the circumferential direction.

As shown in FIG. 2, the rotor cores 210 may be provided on both outer axial sides of the permanent magnets 220 (i.e., a respective rotor core 210 is arranged on an outer axial side of a respective set of permanent magnets 220). Consequently, the stator assembly 100 may be arranged at a center, the permanent magnets 220 may be arranged on both axial sides of the stator assembly 100, and each of the rotor cores 210 may be arranged on an outer axial side of both of the permanent magnets 220.

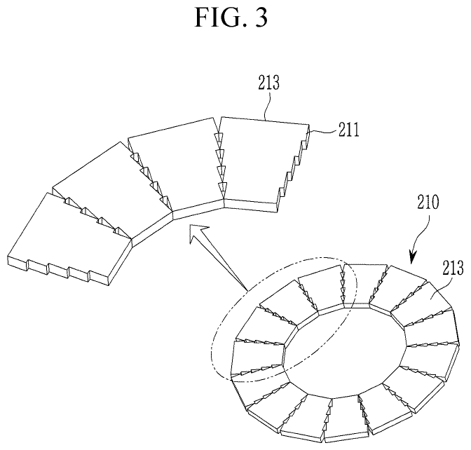

FIG. 3 is a perspective view illustrating a configuration of the rotor core 210 of the axial flux motor according to an embodiment.

Referring to FIG. 3, the rotor core 210 includes a plurality of block segments 213 in which a plurality of block units 211 formed in an arc shape are stacked in a radial direction. The plurality of block segments 213 are coupled along the circumferential direction to form the rotor core 210 having a ring shape.

When a plurality of block segments 213 are coupled in the circumferential direction to form the ring-shaped rotor core 210, air gaps formed between the block segments 213 are filled with a glass fiber reinforcement polymer (GFRP) material.

The block unit 211 formed in the arc shape may have a thickness set in the radial direction. The block unit 211 formed in the arc shape may have a diameter and a circumferential length, which increase from a radially inner side toward a radially outer side. Accordingly, when the plurality of block units 211 are stacked in the radial direction, a fan shape with a cut-out central portion can be formed.

The rotor core 210 may be manufactured using an electrical steel sheet. By manufacturing the rotor core 210 using the electrical steel sheet, iron loss due to eddy currents generated in the rotor core 210 can be reduced, which can improve the efficiency of the axial flux motor.

In addition, when manufacturing each block unit constituting the block segment 213 of the rotor core 210, the manufacturing of the block unit can be facilitated by manufacturing each block unit by axially stacking electrical steel plates with the same size.

When the permanent magnets 220 are arranged between the rotor cores 210 and the stator assembly 100, the first pole magnets 221 may be arranged between the block segments 213 and the stator core 110, and the second pole magnet 222 may be arranged between a boundary of the block segments 213 and the stator core 110. In other words, the first pole magnets 221 may be arranged at an axially lower portion of a circumferential center of the block segment 213, and the second pole magnets 222 may be arranged at an axially lower portion of a portion where the block segments 213 adjacent to each other are coupled.

In this case, a saturation of a back yoke of the rotor core 210 may be configured to be minimized at the boundary of the block segments 213.

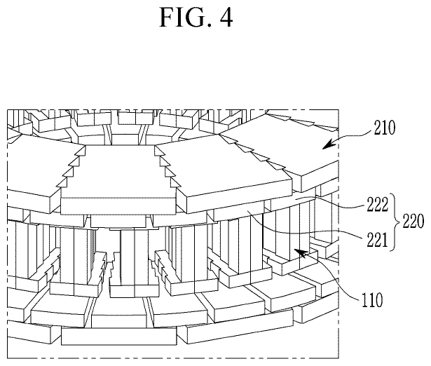

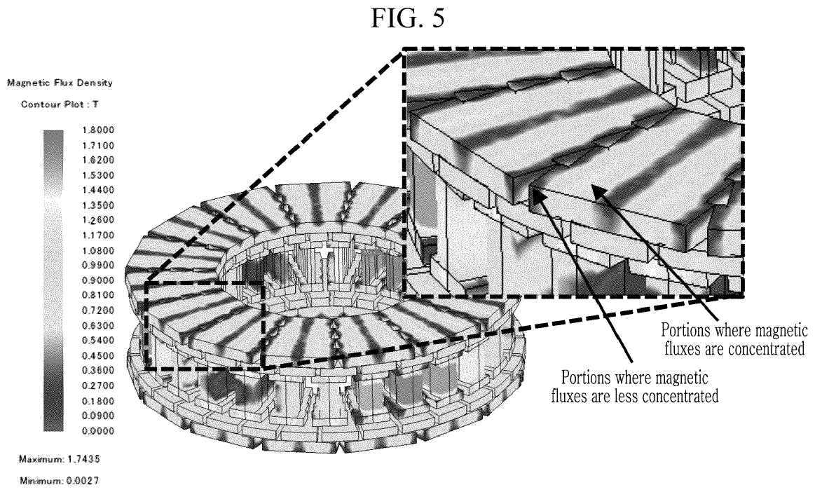

For axial flux motors, axial magnetic fluxes interlink with each other while forming a closed loop. Since the magnetic fluxes in the rotor back yoke follow predetermined paths, portions where the magnetic fluxes are relatively concentrated and portions where the magnetic fluxes are relatively less concentrated occur repeatedly (or continuously). For example, portions where the magnetic fluxes are relatively concentrated and portions where the magnetic fluxes are relatively less concentrated may occur repeatedly every 180 degrees of an electrical angle (see FIGS. 4 and 5).

In the rotor back yoke, portions where the magnetic fluxes are relatively concentrated and portions where the magnetic fluxes are relatively less concentrated appear continuously. For example, portions where the magnetic fluxes are relatively concentrated and portions where the magnetic fluxes are relatively less concentrated may be formed continuously in the rotor back yoke at intervals of 180 degrees of the electrical angle. In terms of the magnetic circuit, less saturated portions of the back yoke do not have a relatively significant effect on the performance of the motor.

In an embodiment, since the less saturated portion of the back yoke is configured to be located at the boundary of the block segments 213, it can be seen that, from the perspective of the magnetic circuit, even when the rotor core 210 is formed by the coupling of the block segments 213 in which the block units 211 are stacked in the radial direction, the influence on the magnetic circuit of the motor is minimal.

For reference, it can be confirmed from the analysis result using the FEM (finite elements method) that the saturation of magnetic fluxes at the boundary of the block segments 213 is not large. In other words, it can be seen that the block segment 213 having an angle that is a multiple of 180 degrees of the electrical angle does not affect the performance of the motor.

Hereinafter, an axial flux motor according to another embodiment is described in detail with reference to the accompanying drawings.

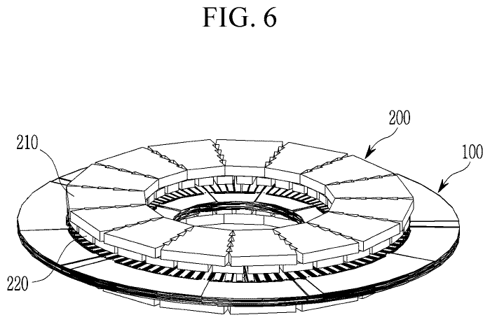

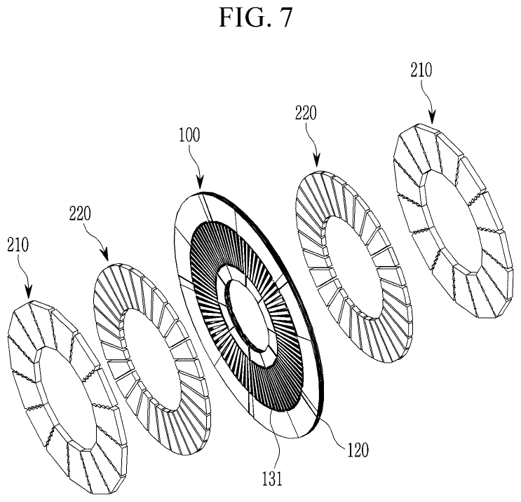

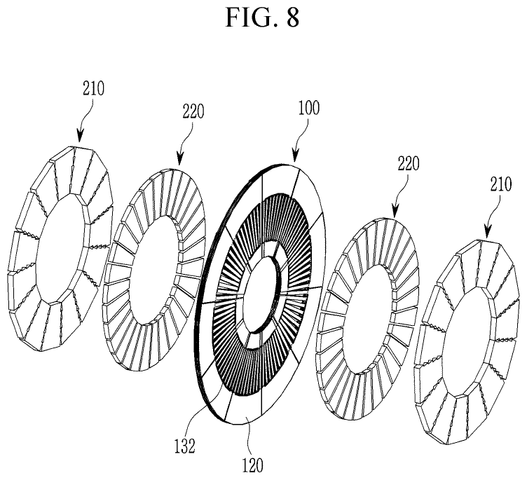

FIG. 6 is a perspective view illustrating a configuration of an axial flux motor according to another embodiment. FIGS. 7 and 8 are exploded perspective views illustrating the configuration of the axial flux motor according to the embodiment of FIG. 6.

The axial flux motor illustrated in FIGS. 6-8 is different only in the structure of the rotor assembly 200 of the axial flux motor described above with reference to FIGS. 1-5. Thus, only the parts that are different from those of the axial flux motor described with reference to FIGS. 1-5 are described.

Referring to FIGS. 6-8, a stator assembly 100 according to another embodiment may include a stator body 120, an upper stator coil 131, and a lower stator coil 132.

The stator body 120 may be formed in a disc shape and may be configured as a printed circuit board (PCB).

The upper stator coil 131 may be wound on one surface (e.g., an upper surface) of the stator body 120. The lower stator coil 132 may be wound on the other surface (e.g., a lower surface) of the stator body 120. In other words, the upper stator coil 131 may be wound with a very thin thickness on the upper surface of the stator body 120, and the lower stator coil 132 may be wound with a very thin thickness on the lower surface of the stator body 120. In other words, the stator assembly 100 may be implemented in the form of a PCB stator, in which the stator coils 130 are formed on the upper and lower surfaces of the stator body 120, respectively.

The structure in which the rotor assembly 200 is arranged on each of both axial sides of the stator assembly 100 is the same as described above, so the detailed description has been omitted.

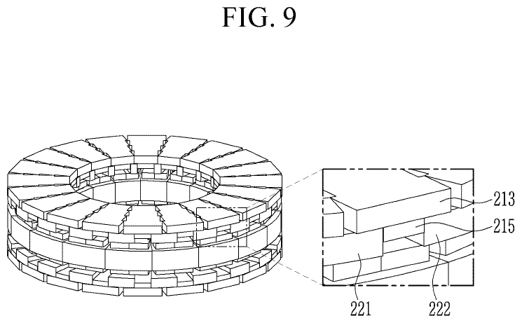

FIG. 9 is a perspective view illustrating a configuration of an axial flux motor according to still another embodiment.

The axial flux motor illustrated in FIG. 9 is different only in the structure of the rotor assembly 200 of the axial flux motor described above with reference to FIGS. 1-5. Thus, only the parts that are different from those of the axial flux motor described with reference to FIGS. 1-5 are described.

Referring to FIG. 9, a block support member 215 may be formed at a lower portion of the block segment 213 of the rotor core 210. The block support member 215 may be formed to extend downward from a circumferential center of the block segment 213.

When the plurality of block segments 213 are coupled along the circumferential direction to form a ring shape, the permanent magnets 220 may be arranged between the block support members 215. By arranging the permanent magnets 220 between the block support members 215, the coupling between the rotor core 210 and the permanent magnets 220 can be facilitated.

According to an axial flux motor according to an embodiment, by applying electrical steel sheets to the rotor core 210, the rotor core 210 exhibits the BH characteristics (relationship among the current flux density B, the demagnetizing force H, and the maximum energy product BH) superior to those of a rotor core 210 using an SMC core (soft magnetic composite core). In addition, each electrical steel plate forming the block segments 213 is stacked in an insulated state, which is advantageous in reducing iron loss due to eddy currents.

The axial flux motor according to the disclosed embodiments may be applied to an electric water pump (EWP) of a vehicle.

By applying the axial flux motor according to the disclosed embodiments to the electric water pump, an axial size of the electric water pump can be minimized. In addition, by arranging the rotor assembly 200 including the permanent magnets 220 on the upper and lower sides of the stator assembly 100, respectively, the torque of the drive motor can be increased in a narrow space within a housing.

While the present disclosure has been described in connection with what is presently considered to be practical embodiments, it is to be understood that the present disclosure is not limited to the disclosed embodiments. On the contrary, it is intended to cover various modifications and equivalent arrangements included within the spirit and scope of the appended claims.

### DESCRIPTION OF SYMBOLS

100: stator assembly
110: stator core
111: stator tooth
112: stator slot
113: stator shoe
120: stator body
130: coil
131: upper stator coil
132: lower stator coil
200: rotor assembly
210: rotor core
211: block unit
213: block segment
215: block support member
220: permanent magnet
221: first pole magnet
222: second pole magnet

What is claimed is:

1. A rotor core comprising:
a plurality of block units formed in an arc shape,
wherein the plurality of block units are stacked in a radial direction, and
wherein the plurality of block units are coupled along a circumferential direction to form a ring shape.

2. The rotor core of claim 1, wherein:
the plurality of block units have a diameter and a circumferential length that increase from a radially inner side toward a radially outer side.

3. An axial flux motor comprising:
a stator assembly comprising a stator core and a coil wound around the stator core; and
a rotor assembly configured to rotate by an electromagnetic action with the stator assembly,
wherein the rotor assembly comprises:
permanent magnets provided on both axial sides of the stator assembly; and
rotor cores each provided on an outer axial side of the permanent magnets, the rotor cores including block segments in which a plurality of block units formed in an arc shape are stacked in a radial direction and formed in a ring shape by the block segments being coupled in a circumferential direction.

4. The axial flux motor of claim 3, wherein:
the plurality of block units of the rotor core have a diameter and a circumferential length that increase from a radially inner side toward a radially outer side.

5. The axial flux motor of claim 3, wherein:
air gaps formed between the block segments are filled with a glass fiber reinforcement polymer material.

6. The axial flux motor of claim 3, wherein:
the permanent magnets include first pole magnets and second pole magnets having a different polarity from the first pole magnets; and
wherein the first pole magnets and the second pole magnets are arranged at equal intervals along the circumferential direction.

7. The axial flux motor of claim 6, wherein:
the first pole magnets are arranged between the block segments and the stator core; and
wherein the second pole magnets are arranged between boundaries of the block segments and the stator core.

8. The axial flux motor of claim 7, wherein:
saturation of a back yoke is minimized at the boundaries of the block segments.

9. The axial flux motor of claim 3, wherein the stator core comprises:
stator teeth spaced apart at set intervals along the circumferential direction;
stator slots each formed between the stator teeth, the coil being wound in the stator slots; and
stator shoes extending from radially inner sides of the stator teeth toward the stator slots.

10. The axial flux motor of claim 3, wherein the stator assembly comprises:
a stator body;
an upper stator coil wound on an upper surface of the stator body; and
a lower stator coil wound on a lower surface of the stator body.

11. The axial flux motor of claim 3, further comprising block support members formed at lower portions of the block segments of the rotor core.

12. The axial flux motor of claim 11, wherein the permanent magnets are arranged between the block support members.
